(19) United States
(12) Patent Application Publication
(10) Pub. No.: US 2023/0120516 A1
(43) Pub. Date: Apr. 20, 2023

(54) COMPUTATION GRAPH OPTIMIZATION BY PARTIAL EVALUATIONS

(71) Applicant: NEC Laboratories Europe GmbH, Heidelberg (DE)

(72) Inventors: Nicolas Weber, Heidelberg (DE); Daniel Thuerck, Heidelberg (DE)

(21) Appl. No.: 17/572,740

(22) Filed: Jan. 11, 2022

Related U.S. Application Data
(60) Provisional application No. 63/255,972, filed on Oct. 15, 2021.

(51) Int. Cl. G06N 3/063

(52) U.S. Cl. CPC G06N 3/063

(57) ABSTRACT

A method for optimizing a neural network includes identifying parameters of a computation graph of the neural network that depend on input data as a computation part, and parameters of the computation graph that are independent of the input data as a pre-evaluation part. The method splits the computation graph into the pre-evaluation part and the computation part, and generates and applies a wrapper that performs a transparent mapping of data layouts of the pre-evaluation part.

### CROSS-REFERENCE TO RELATED APPLICATION

Priority is claimed to U.S. Provisional Patent Application No. 63/255,972, filed on Oct. 15, 2021, the entire disclosure of which is hereby incorporated by reference herein.

### FIELD

The present invention relates to artificial intelligence (AI), neural networks and machine learning, and in particular to a method, system and computer-readable medium for optimizing computation graphs by partial evaluations.

### BACKGROUND

Modern AI frameworks allow the user to provide the data in a so called NCHW (batch_size, channels, height, width) or channel-first data layout or in a so called NHWC (batch_size, height, width, channels) or channels-last data layout. While these data layouts are easy to use and well established in the community, the performance of these AI frameworks is significantly lower than if the data would be organized in a way that perfectly fits the implementation and the hardware's memory system. Therefore, highly optimized neural network libraries such as the oneAPI Deep Neural Network (OneDNN) library, the CUDA Deep Neural Network (CUDNN) library and other similar libraries require to convert the data to an optimized memory layout to ensure peak performance.

### SUMMARY

An embodiment of the present invention provides a method for optimizing a neural network. The method comprises identifying parameters of a computation graph of the neural network that depend on input data as a computation part and parameters of the computation graph that are independent of the input data as a pre-evaluation part, splitting the computation graph into the pre-evaluation part and the computation part, and generating and applying a wrapper that performs a transparent mapping of data layouts of the pre-evaluation part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an exemplary neural network computation graph;

FIG. 2 illustrates an exemplary neural network that has been specialized to use Deep Neural Network (DNN) libraries that require memory layout transformations;

FIG. 3 illustrates an exemplary neural network that uses pre-evaluated parameters;

FIG. 4 illustrates a partial neural network of pre-evaluation parameters;

FIG. 5 illustrates an inflexible neural network implementation of AI frameworks, that cannot change their parameters, wherein interaction of the neural network and a user is shown on the left;

FIG. 6 illustrates a two-level neural network with a wrapper that can exchange the neural network when needed without the user noticing;

FIG. 7 illustrates a workflow when the user triggers execution of the neural network; and

FIG. 8 illustrates a workflow for exporting, storing or deploying of the neural network.

### DETAILED DESCRIPTION

Embodiments of the present invention provide a system, method and computer-readable medium for optimizing computation graphs by partial evaluations by identifying transformations that can be evaluated ahead of the execution of the model, and performing a pre-evaluation. This allows for reducing the computation and execution time needed to execute the model. The reduction of computation time needed also provides for additional computations to be performed, and/or allows to save computational resources, thereby reducing the computational cost of repetitious computations with a significantly improved computational run-time and without a loss of accuracy. Moreover, various embodiments of the present invention provide for enhanced transparency of parameter configuration within a neural network.

OneDNN for X86 instruction set architectures requires convolution inputs to be in a channel-blocked layout that splits the channel dimension into two parts. The channels get split into an inner and outer part, where the blocking size depends on the used vector instructions, e.g., AVX2: block_size=8, AVX512: block_size=16. This requires to reshape, permute and sometimes also to add padding to the original data. For recurrent neural network (RNN) layers, it uses a similar blocked format.

CUDNN requires convolution inputs to be in NHWC layout to map these inputs onto its high performance tensor cores. For RNN layers, CUDNN needs to merge all input parameters (bias, weights) into a single, large consecutive memory segment.

Long vector platforms such as the SX-AURORA of the company NEC CORP. with vector lengths of 256 and 512 elements benefit from padding the pixel-dimensions in pooling and convolution layers (indicated by the “HW” in NCHW and NHWC) to the size of their vector length, to prevent expensive boundary checks. This increases the memory size, but enables removing costly boundary checks during execution.

Also, the performance of matrix-multiplications (e.g., general matrix vector multiplication (GEMV), general matrix multiply (GEMM), etc.) is highly dependent on the used transposition of the input matrices. Usually, it is beneficial to vectorize the output channels of the layer.

However, AI frameworks typically only support the generic NHWC or NCHW layouts, such that, during the execution, the memory layout needs to be converted into the desired layout before the execution of each layer, and then converted back again, which wastes costly computational time and computational resources. Further, this process has to be repeated in every mini-batch and epoch during training, and is therefore executed thousands of times.

Another case where expensive repetition of computations occurs is when generating layers such as Arange, Zeros, Ones, Eye, Constant, or equivalents are used. For example, in bidirectional encoder representations from transformers (BERT) networks, if the user does not use all inputs, the unused inputs get automatically initialized with zeros, so that the following embedding layer can be statically evaluated.

Hardware specialized AI libraries require hardware specific memory layouts to achieve peak performance. However, due to the increased number of AI hardware platforms, AI frameworks hide this abstraction from the user, which results in higher execution times because layout transformation functions need to be executed at runtime.

Aspect (1): In an aspect (1), the present invention provides a method for optimizing a neural network. The method includes identifying parameters of a computation graph of the neural network that depend on input data as a computation part, and parameters of the computation graph that are independent of the input data as a pre-evaluation part, splitting the computation graph into the pre-evaluation part and the computation part, and generating and applying a wrapper that performs a transparent mapping of data layouts of the pre-evaluation part.

Aspect (2): In an aspect (2), the present invention provides the method according to the aspect (1), wherein the wrapper computes the transparent mapping between a default artificial intelligence (AI) framework layout and a compute library layout of the neural network, generates code implementing the transparent mapping between the default AI framework layout and the compute library layout, and generates a new neural network from the neural network by injecting the code into an execution of the neural network.

Aspect (3): In an aspect (3), the present invention provides the method according to the aspect (2), wherein the aspect (2) further includes executing the new neural network.

Aspect (4): In an aspect (4), the present invention provides the method according to the aspects (2) or (3), wherein the aspect (4) further includes exporting, storing or deploying the neural network, and reversing, by the wrapper, the transparent mapping back to the default AI framework layout.

Aspect (5): In an aspect (5), the present invention provides the method according to the aspects (1), (2), (3), or (4), wherein the transparent mapping of data layouts of the pre-evaluation part includes a parameter update.

Aspect (6): In an aspect (6), the present invention provides the method according to the aspects (1), (2), (3), (4), or (5), wherein the aspect further comprises performing the transparent mapping of data layouts of the pre-evaluation part, executing the neural network, and applying a gradient update to the transparently mapped data layout of the pre-evaluation part.

Aspect (7): In an aspect (7), the present invention provides the method according to the aspects (1), (2), (3), (4), (5), or (6), wherein the aspect further comprises performing the transparent mapping of data layouts of the pre-evaluation part, receiving a request to export the neural network from a current data layout to a subsequent data layout, and executing the transparent mapping of data layouts of the pre-evaluation part backwards.

Aspect (8): In an aspect (8), the present invention provides the method according to the aspects (1), (2), (3), (4), (5), (6), or (7), wherein the aspect further comprises performing the transparent mapping of data layouts of the pre-evaluation part and storing an output of the pre-evaluation part in the neural network, wherein the pre-evaluation part comprises a generative layer.

Aspect (9): In an aspect (9), the present invention provides the method according to the aspects (1), (2), (3), (4), (5), (6), (7), or (8), wherein handling the transparent mapping of the data layouts by the wrapper comprises receiving a parameter of the neural network, generating a new neural network with a new parameter, performing the transparent mapping of data layouts of the pre-evaluation part using the parameter of the neural network as an input and the new parameter of the new neural network as an output, and replacing the neural network with the new neural network.

Aspect (10): In an aspect (10), the present invention provides the method according to the aspects (1), (2), (3), (4), (5), (6), (7), (8), or (9), wherein handling the transparent mapping of the data layouts by the wrapper comprises detecting a data layout of the neural network, detecting a data layout of a target device that will deploy the neural network, creating a new neural network with the data layout of the target device, and replacing the neural network with the new neural network.

Aspect (11): In an aspect (11), the present invention provides the method according to the aspect (10), wherein the wrapper detects the data layout of the neural network and detects the data layout of the target device that will deploy the neural network in response to a user execution of the neural network.

Aspect (12): In an aspect (12), the present invention provides the method according to the aspects (1), (2), (3), (4), (5), (6), (7), (8), (9), (10), or (11), wherein the aspect further comprises detecting a data layout of the neural network, detecting a data layout of a target device that will deploy the neural network, performing the transparent mapping of data layouts of the pre-evaluation part, and replacing the neural network with a neural network that utilizes a data layout of the target device.

Aspect (13): In an aspect (13), the present invention provides the method according to the aspects (1), (2), (3), (4), (5), (6), (7), (8), (9), (10), (11), or (12), wherein the aspect further comprises removing, by the wrapper, a parameter of the neural network in response to a user input.

Aspect (14): In an aspect (14), the present invention provides a system including one or more hardware processors which, alone or in combination, are configured to provide for execution of the steps of identifying parameters of a computation graph of the neural network that depend on input data as a computation part and parameters of the computation graph that are independent of the input data as a pre-evaluation part, splitting the computation graph into the pre-evaluation part and the computation part, and generating and applying a wrapper that performs a transparent mapping of data layouts of the pre-evaluation part.

Aspect (15): In an aspect (15), the present invention provides the method according to a tangible, non-transitory computer-readable medium having instructions thereon which, upon being executed by one or more hardware processors, alone or in combination, provide for execution of the steps of identifying parameters of a computation graph of the neural network that depend on input data as a computation part and parameters of the computation graph that are independent of the input data as a pre-evaluation part, splitting the computation graph into the pre-evaluation part and the computation part, and generating and applying a wrapper that performs a transparent mapping of data layouts of the pre-evaluation par.

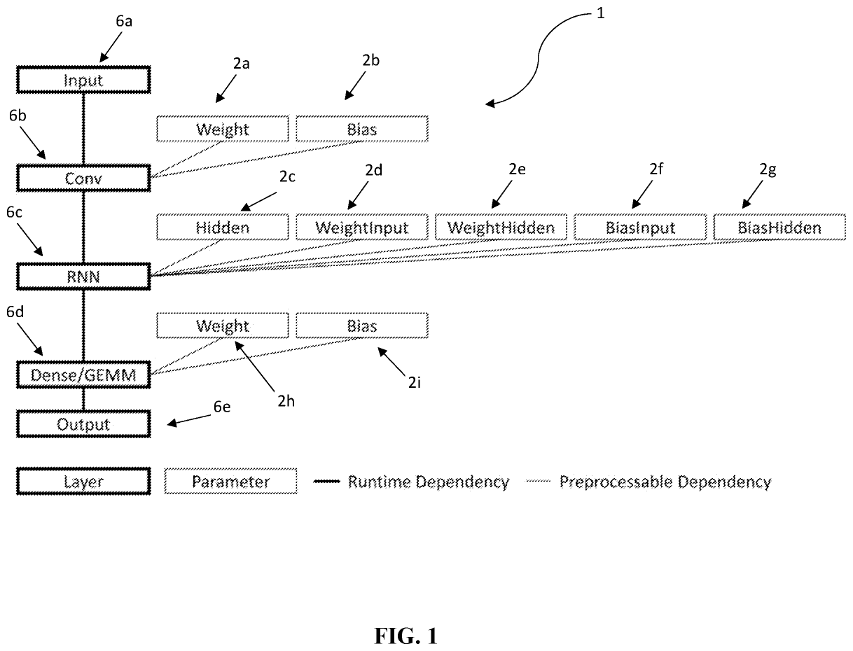

FIG. 1 shows a computation graph 1 including an input layer 6a, a convolutional layer 6b, an RNN layer 6c, a dense/GEMM layer 6d and an output layer 6e. The convolutional layer 6b of the embodiment of FIG. 1 includes weight 2a and bias 2b parameters. In the embodiment of FIG. 1, the weight 2a parameter is the convolution weights, and the bias 2b parameter is the convolution bias. The RNN layer 6c includes multiple parameters 2, such as hidden 2c, weightinput 2d, weighthidden 2e, biasinput 2f, and biashidden 2g. The hidden 2c parameter of FIG. 1 refers to the initial hidden state of the layer, often represented by a zero value. The weightinput 2d parameter is a weight that gets matrix multiplied onto the inputs of the layer. The weighthidden 2e parameter is a weight that gets matrix multiplied onto the hidden state of the layers. The biasinput 2f parameter is a bias that gets added after input weights have been applied. The biashidden 2g parameter is a bias 2g that gets added after the hidden weights of the weighthidden 2e parameter have been applied. The dense/GEMM layer 6d portion of the neural network computation graph 1 includes the parameters 2 of weight 2h and bias 2i. The weight 2h parameter of the dense/GEMM layer 6d is a weight of a matrix multiplication of the dense/GEMM layer. The bias 2i parameter of the dense/GEMM layer 6d is a bias that gets added to the layer after the weights 2h have been multiplied.

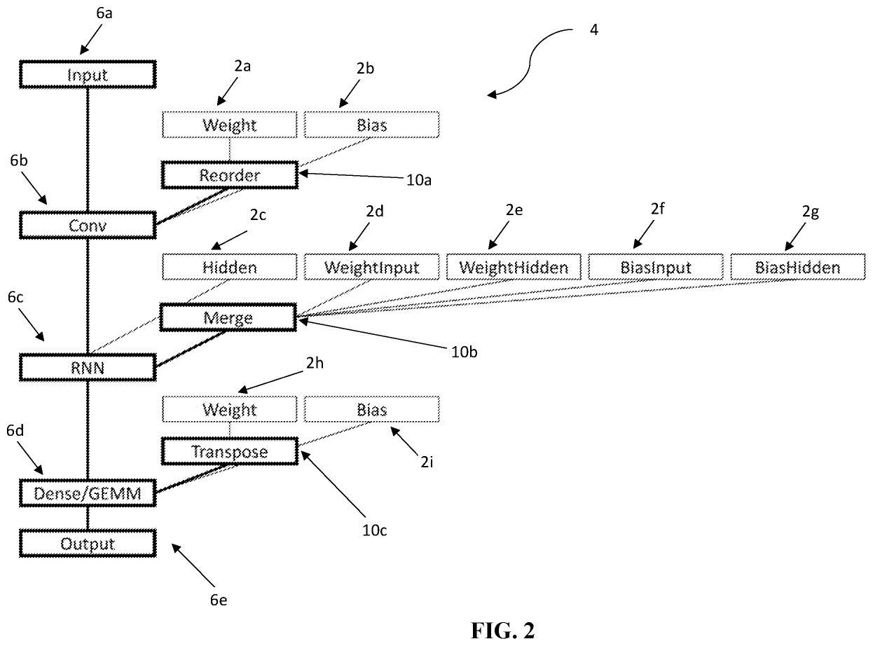

FIG. 2 shows a computation graph 4 of a neural network that is specialized to use specific neural network libraries and also includes an input layer 6a, a convolutional layer 6b, an RNN layer 6c, a dense/GEMM layer 6d and an output layer 6e. In addition to the parameters 2 of the convolutional layer 6b, RNN layer 6c, and dense/GEMM layer 6d of FIG. 1, the neural network computation graph that is specialized to use specific neural network libraries 4 includes an additional transformation function 10 in each of the convolutional layer 6b, RNN layer 6c, and Dense/GEMM layer 6d layers. Convolutional layer 6b includes a reorder function 10a, RNN 6c includes a merge function 10b, and dense/GEMM 6d includes a transpose function 10c. Exemplary reorder functions 10a, merge functions 10b, and transpose functions 10c are shown below.

| | |
|---|---|
| 1 | def merge(A, B, C): |
| 2 | Asize, Bsize, Csize = prod(A.shape), prod(B.shape), prod(C.shape) |
| 3 | |
| 4 | output = malloc(Asize + Bsize + Csize); |
| 5 | Aoutput = output |
| 6 | Boutput = Aoutput + Asize |
| 7 | Coutput = Boutput + Bsize |
| 8 | |
| 9 | memcpy(Aoutput, A, Asize) |
| 10 | memcpy(Boutput, B, Bsize) |
| 11 | memcpy(Coutput, C, Csize) |
| 12 | |
| 13 | return output |
| 14 | |
| 15 | def transpose(A): |
| 16 | B = malloc(A.shape[1], A.shape[0]) |
| 17 | for y in len(A.shape[0]): |
| 18 | for x in len(A.shape[1]): |
| 19 | B[y][x] = A[x][y] |
| 20 | return B |
| 21 | |
| 22 | ## The Reorder function is very complex and uses a series of operations |
| 23 | such as reshape, padding, permute, slice, ... depending on the necessary |
| 24 | transformation |
| 26 | |
| 27 | ## Example for Reorder from [Batch, Channels, PixelY, PixelX] to [Batch, |
| 28 | PaddedChannels/16, PixelY, PixelX, PaddedChannels%16] |
| 29 | |
| 30 | # compute how much padding we need to apply |
| 31 | if Channels % 16 != 0: PaddedChannels = Channels + (16 − (Channels % 16)) |
| 32 | else: PaddedChannels = Channels |
| 33 | |
| 34 | # ensure that Channels is dividable by 16 |
| 35 | x = pad(x, [0, PaddedChannels-Channels, 0, 0)) |
| 36 | |
| 37 | # split Channels dimension |
| 38 | x = reshape(x, [Batch, PaddedChannels/16, PaddedChannels%16, PixelY, PixelX]) |
| 39 | |
| 40 | # permute Channels dimension |
| 41 | x = permute(x, [0, 1, 3, 4, 2]) |
| 42 | |
| 43 | ## Example for Reorder from [Batch][Channels/16][PixelY][PixelX][Channels%16] |
| 44 | to [Batch][Channels][PixelY][PixelX] |
| 45 | |
| 46 | # permute Channels dimension |
| 47 | x = permute(x, [0, 1, 4, 2, 3]) |
| 48 | |
| 49 | # merge Channel dimension |
| 50 | x = reshape(x, [Batch, PaddedChannels, PixelY, PixelX]) |
| 51 | |
| 52 | # remove padding |
| 53 | x = x[:, 0:Channels, :, :] |

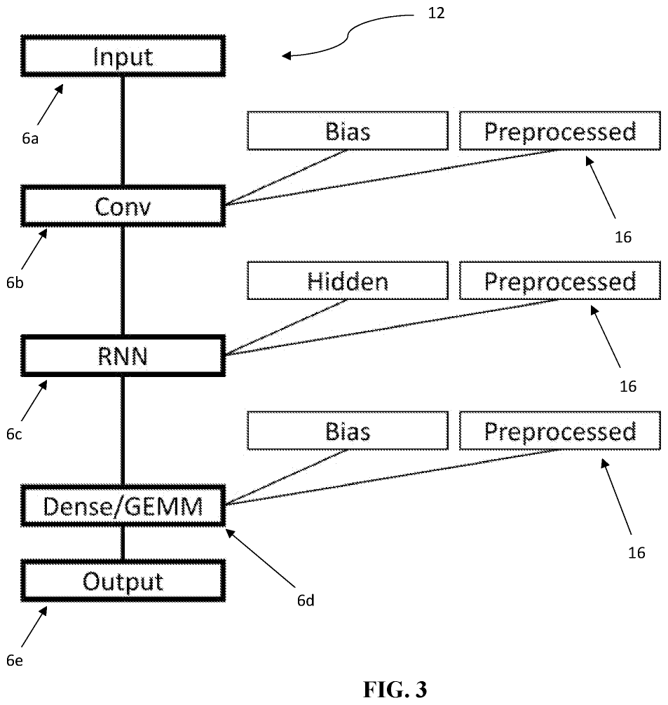

Considering the neural network computation graph 1 of FIG. 1, and the neural network computation graph that is specialized to use specific neural network libraries 4, such as is shown in FIG. 2, it has been recognized in accordance with embodiments of the present invention that there are sections containing pre-evaluable model parameters 2 within the computation graphs that get executed every time the model gets executed, but are independent of the input data 6a and therefore can be precomputed (indicated by thin lines). Such a precomputation, however, has not been considered in any of the AI frameworks. One reason for this could be that these model parameters 2 need to be updated during training through the AI framework after each epoch. However, embodiments of the present invention recognize that the parameter update is independent of the shape and number of parameter values, in particular if there is padding, and can be applied also on intermediate results, e.g., pre-evaluated parameters such as weight 2h, weightinput 2d, weighthidden 2e, biasinput 2f, biashidden 2g, and weight 2a. Other parameters can also be the subject of a pre-evaluation parameter update based on whether the parameter has one or multiple dimensions. For example other parameters, such as bias 2b or hidden 2c parameter, might not be pre-evaluated, such as in the embodiment of FIG. 3, when the parameters are one dimensional. Embodiments of the present invention can also change the location where the data, such as input data 6a, is stored in memory without any real mathematical operation or change in algorithm.

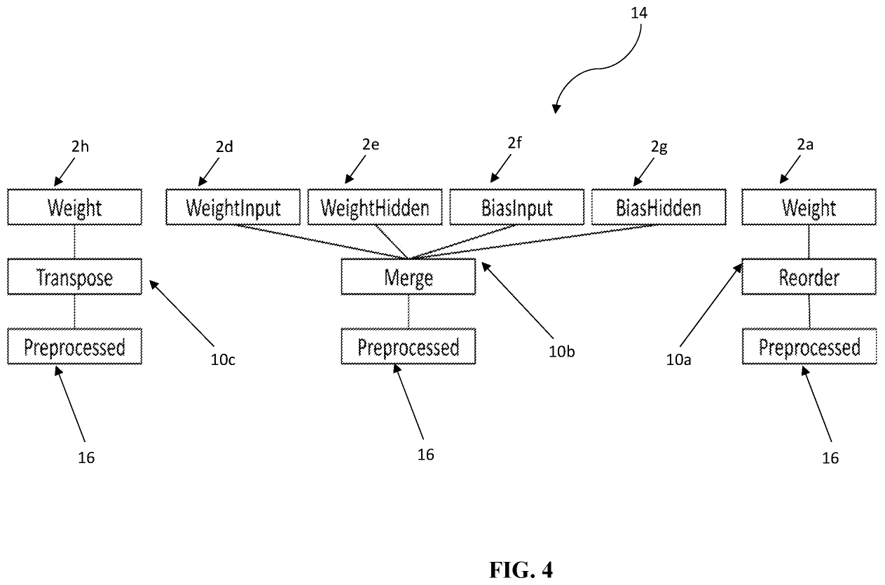

Embodiments of the present invention provide to precompute the transformation functions 10 to get a neural network 12 such as the one shown in FIG. 3. In particular, according to embodiments of the present invention, the partial neural network 14 shown in FIG. 4 is run once ahead of the computation to transform the neural network 12 of FIG. 3 into the device specific state. By pre-evaluating the input independent parameters of parameters 2 of weight 2h, weightinput 2d, weighthidden 2e, biasinput 2f, biashidden 2g, and weight 2a, and then pre-evaluating the transformation reorder function 10a, merge function 10b, and transpose function 10c of the neural network 12, the gradient updates yielded from the partial neural network 14 can be applied to the pre-evaluated parameters 16 of FIG. 3 with no negative side effects. This neural network 12 can then be used normally by the user, without any limitations or drawbacks on accuracy. When the neural network 12 is stored, exported, deployed, executed on another device, etc., then the partial network 14 is executed backwards to propagate the gradient updates back into the original data layout. In the exemplary embodiment of FIG. 3, the bias 2b and bias 2i parameters are a one dimensional array, and as a result do not need to be processed.

This approach according to embodiments of the present invention can also be applied to the previously mentioned generative layers, such as the “Zeros>Embedding” case. In this case, the two layers are precomputed and the output of the embedding is stored as the pre-evaluated parameters 16 in the optimized neural network.

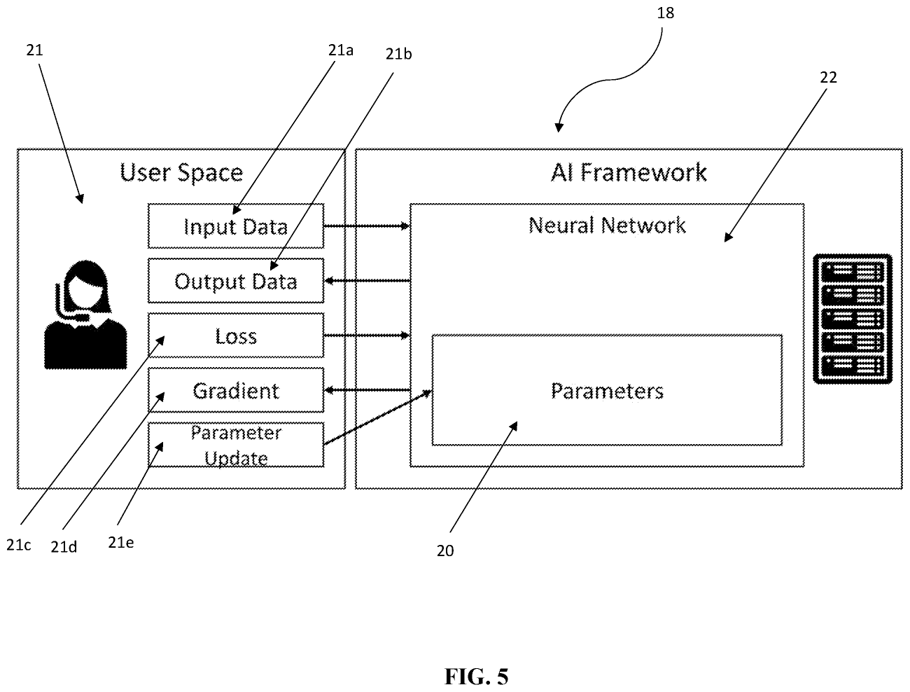

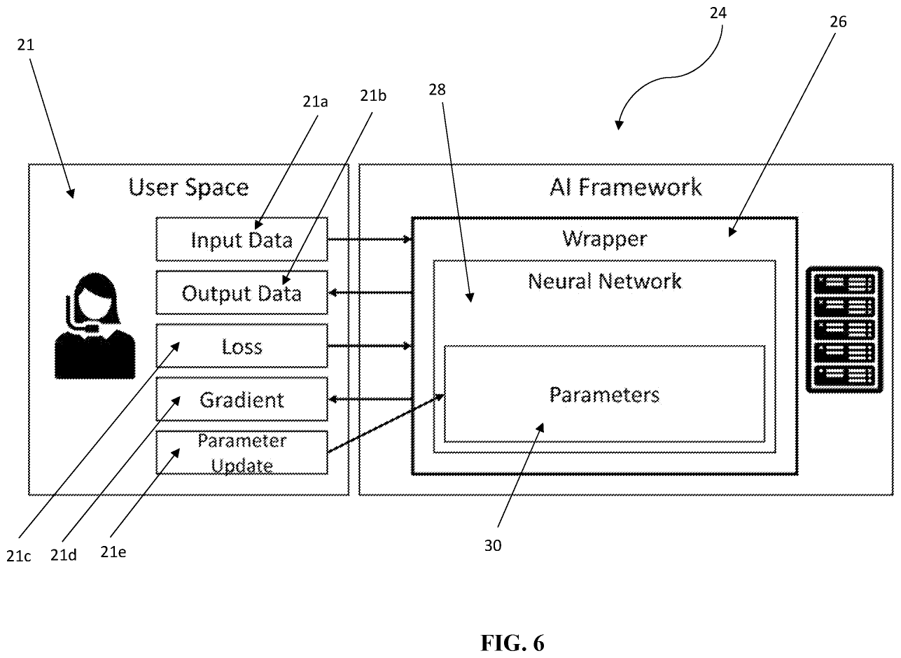

Embodiments of the present invention also provide for implementing padded memory layouts and merging of parameters. Compute libraries provide functions, e.g., reorder function 10a, merge function 10b, and transpose function 10c, for implementation to compute the layers, e.g., RNN layer 6c, dense/GEMM layer 6d, etc., and AI frameworks can use the compute libraries to perform the computations of the layers. As illustrated by FIG. 5, the user space 21 of modern AI frameworks 18 allow for a user to handle input data 21a, output data 21b, loss 21c and gradient 21d information. However, modern AI frameworks 18 are very inflexible in that the number of parameters 20 within the model 22 cannot be changed by a parameter update 21e in any of the frameworks once the model 22 is built. Although PyTorch is an exception and allows adding parameters via the parameter update 21e, PyTorch does not provide for removing parameters 20. Further, except for this aspect of PyTorch, none of the AI frameworks 18 allow for changing the shape or number of elements within a parameter 20. This only allows for implementing permutations/transpositions in the AI frameworks 18, and does not allow for padded memory layouts or merging of multiple parameters. To overcome these problems, embodiments of the present invention provide to use a two-level AI network implementation 24 such as shown in FIG. 6, where the outer one behaves as a calling-wrapper 26. When the user or the application triggers the execution of the neural network 28, this wrapper 26 checks on which device the neural network 28 shall be executed. If memory layout transformations are required, the wrapper 26 generates a new instance of the neural network 28 with the necessary parameters 30 and shapes, and then executes the pre-evaluation step, with the old neural network parameters as input and the new neural network parameters as output 44. Then, the wrapper 26 frees the old neural network and replaces it with the new neural network.

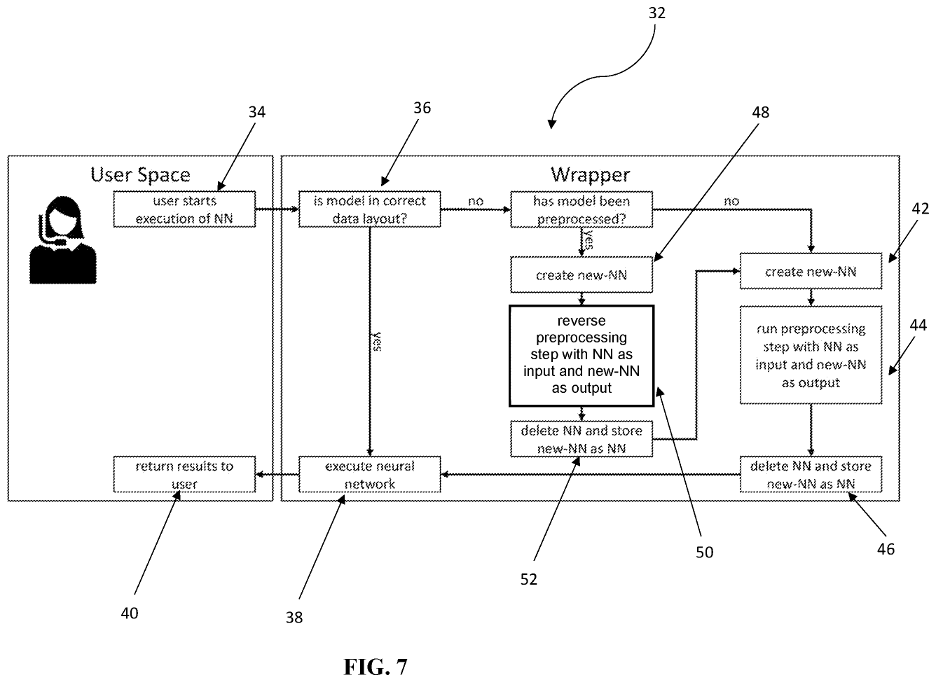

FIG. 7 shows an exemplary workflow 32 when the user then triggers the execution of the neural network 34, broken into exemplary steps. This workflow only needs to be done once when the execution device changes and therefore has only a negligible impact on the performance, especially during training as the neural network then gets executed thousands of time. If the data is already in the required data layout at step 36, it does not need to be further processed and the neural network can be executed 38, and the results returned to the user 40 (see path yes in FIG. 7). If the data is in a default layout, or an incorrect layout, it is converted into the target device's layout (see path no→no, in FIG. 7) by creating a new neural network at step 42, running the pre-evaluating step with the old neural network as input and new neural network as the output at step 44, and deleting the old neural network and storing the new neural network as the neural network at step 46. If the data is in the layout of a different device, it is first converted to the default layout first (see path no→yes in FIG. 7). Converting to the default layout occurs through creating a new neural network at step 48, reversing the pre-evaluating step with the old neural network as input and new neural network as the output at step 50, and deleting the old neural network and storing the new neural network as the neural network at step 52, and is then converted into the target device's layout via steps 42, 44, 46.

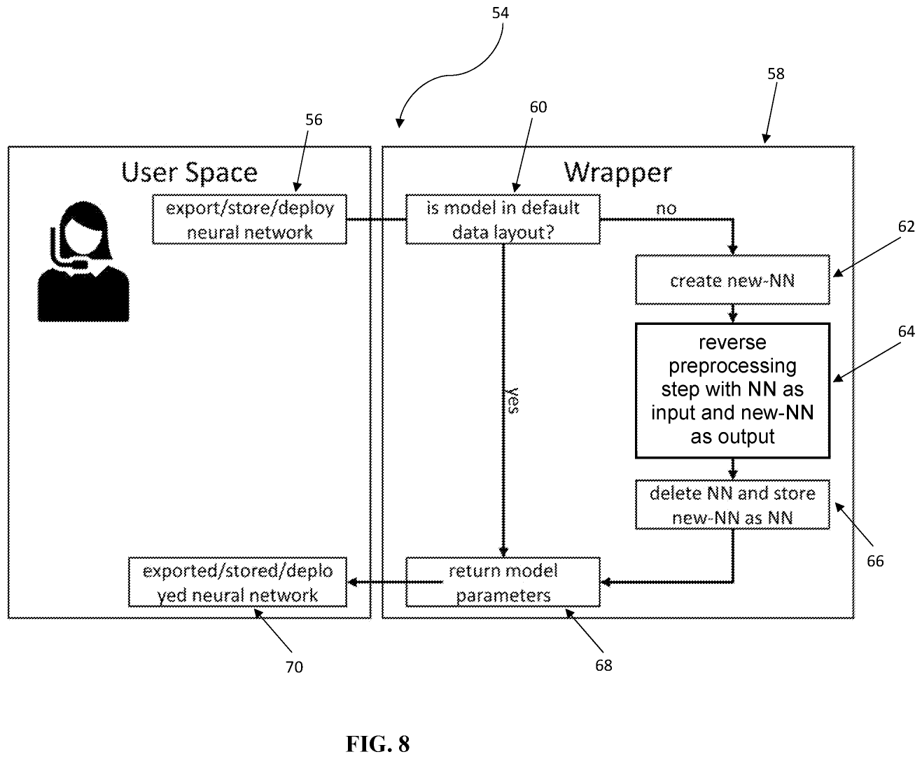

Referring to the exemplary workflow 54 of FIG. 8, if the user wants to store, export or deploy the neural network 56, it first needs to be in the default layout to guarantee that the toolchain the user is using works on the correct memory layouts. If the data is in a device specific layout, then it needs to be converted first before the process can continue. The process, executed by the wrapper 58, for conversion includes first asking if the model is in a default data layout at step 60. If not, the wrapper creates a new neural network at step 62, runs the reverse pre-evaluating step with the old neural network as the input and the new neural network as the output at step 64, deletes the old neural network and stores the new neural network as the current neural network at step 66. The wrapper 58 then returns the model parameters at step 68. If the model is in a default layout at step 60, the wrapper 56 returns or exports the model parameters at step 68. After step 68, the User receives an exported, stored, or deployed neural network at step 70 as requested.

As an example of a memory layout transformation, such as a transformation that would be performed on the parameters of FIG. 4, reference is made to the OneDNN (formerly DNNL) library which targets X86 central processing units (CPUs) and supports AVX2 (8x FP32 simd) and AVX512 (16x FP32 simd) instructions, with respect to which a convolution implementation using NCHW format could be as follows:

```
for (batch in batches) :
  for (outChannel in outChannels) :
    for (y in yPixels) :
      for (x in xPixels) :
      sum = 0.0
      for (inChannel in inChannels) :
        for (ky in yKernel) :
          for (kx in xKernel) :
            sum += input [batch] [inChannel] [y
+ ky] [x + kx] * weight [outChannel] [inChannel] [ky] [kx]
        out [batch] [inChannel] [y] [x] = sum
```

In this example, the input and output data are arranged as “Batches”, “Channels”, “Y”, “X” and the weights are arranged as “OutChannels”, “InChannels”, “YKernel”, “XKernel”. However, in neural networks the pixel sizes are rarely dividable by 8 or 16 which is the single instruction multiple data (SIMD) length. Therefore Intel splits the channels dimension into “Batches”, “OuterChannels”, “Y”, “X”, “InnerChannels”, whereas InnerChannels has the same size as the SIMD length. This requires to add a padding if channels are not dividable by the SIMD length. With this adjustment, it is not necessary to have any expensive boundary checks for the channels dimension. Further, channels are chosen over pixels, as there can be one to three pixel dimensions but only one channel dimension and therefore it's easiest to vectorize just this one dimension.

### Embodiment: Training Pipeline

An exemplary training pipeline is as follows:

```
model = initNN ( )
optimizer = SGDOptimizer (model.parameters ( ))
loss_function = L1Loss ( )
for epoch in range (epochs) :
  for input, target in datasets:
    output = model (input)
    loss = loss_function (output, target)
    loss.backward ( )
  optimizer.step ( )
```

There are epochs * len(dataset) iterations of the model. In each of these iterations, the AI frameworks would do the previously mentioned layout transformations. Embodiments of the present invention advantageously provide code to do these layout transformations automatically when executing output=model(input) the very first time through the wrapper that is being used. This code can be injected into an execution of a neural network, for example, as a preface or preliminary portion of the neural network. Without this wrapper, a manual implementation would look like the following code:

```
model = initNN ( )
compute model, partial model = split (model)
partial model.forward ( )
compute model.load state dict (partial model.state dict ( ))
optimizer = SGDOptimizer (compute model.parameters ( ))
loss_function = L1Loss ( )
for epoch in range (epochs) :
  for input, target in datasets:
    output = compute model (input)
    loss = loss_function (output, target)
    loss.backward ( )
  optimizer.step ( )
partial model.backward ( )
model.load state dict (partial model.state dict ( ))
```

Embodiments of the present invention provide for at least the following improvements over existing technology:

1. Splitting the execution of a neural network into a partial evaluation and main computation graph by identifying all layers that are not dependent on runtime input data and moving them into the partial evaluation graph.
2. Using a wrapper that hides changes to the neural network from the user to enable transparently reconfiguring the number, shape, padding, data type and data layout of the parameters within the neural network.
3. Significantly reducing execution time by the pre-evaluable layers being executed only once and not within every iteration. Take, for example, a convolution that takes 10 ms with optimal memory layouts and that, for this convolution, converting from default to optimal layout requires 2 ms. Accordingly, at each iteration, the convolution takes 12 ms in total. If the conversion is moved, however, into a pre-evaluation step in accordance with embodiments of the present invention, the time for processing this layer is reduced by 17%. In a normal neural network setting, there are usually hundreds of these layers within which the operations are run for thousands of iterations during training. Accordingly, using a conservative estimate of 100 (layers)*10,000 (iterations)*2 ms for the conversion=2,000,000 ms=33 mins saving provided by embodiments of the present invention. Despite this significant reduction in execution time, resulting also in savings in computational processing power and computational resources, embodiments of the present invention do not have any negative impact on the accuracy of the process or peak memory consumption.

In an embodiment, the present invention provides a method comprising the following steps:

1. Analysis of the computation graph and looking for runtime data sources to determine which parts can be partially evaluated and which depend on the input data.
2. Splitting of the computation graph into the pre-evaluation and computation parts.
3. Generating a wrapper that handles the transparent mapping of data layouts of the networks needed by the different processor(s).
a. Deducing the mapping of parameters between a standard AI framework layout and the compute library layout.
b. Generate code implementing the mapping between the different layouts.
c. Inject the code into the AI framework execution.

The contents of the following webpages is incorporated by reference herein: <<https://oneapi-src.github.io/oneDNN/dev_guide_reorder.html>>(DNNL Layer that performs the conversion); <<https://docs.nvidia.com/deeplearning/cudnn/developer-guide/index.html #tensor-ops-conv-functions-data-filter-formats>>(CUDNN layout requirements); <<https://pytorch.org/docs/stable/generated/torch.nn.Module.html #torch.nn.Module>>(PyTorch NN Module API, only contains “register_X” no “remove_X” function calls); <<https://docs.nvidia.com/deeplearning/cudnn/api/index.html #cudnnGetRNNWeightParams>>(method to determine address ranges in unified CUDNN RNN weight space, that combines all weights and bias in a single large memory segment); and <<https://pytorch.org/docs/stable/generated/torch.Tensor.to_mkldnn.html?highlight=mkldnn #torch.Tensor.to_mkldnn>>(allows to convert input data manually to MKLDNN/DNNL data format, but does not apply to parameters).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for optimizing a neural network, the method comprising:
identifying parameters of a computation graph of the neural network that depend on input data as a computation part, and parameters of the computation graph that are independent of the input data as a pre-evaluation part;
splitting the computation graph into the pre-evaluation part and the computation part; and
generating and applying a wrapper that performs a transparent mapping of data layouts of the pre-evaluation part.

2. The method of claim 1, wherein the wrapper:
computes the transparent mapping between a default artificial intelligence (AI) framework layout and a compute library layout of the neural network;
generates code implementing the transparent mapping between the default AI framework layout and the compute library layout; and
generates a new neural network from the neural network by injecting the code into an execution of the neural network.

3. The method of claim 2, further comprising executing the new neural network.

4. The method of claim 2, further comprising exporting, storing or deploying the neural network, and reversing, by the wrapper, the transparent mapping back to the default AI framework layout.

5. The method of claim 1, wherein the transparent mapping of data layouts of the pre-evaluation part includes a parameter update.

6. The method of claim 1, further comprising:
performing the transparent mapping of data layouts of the pre-evaluation part;
executing the neural network; and
applying a gradient update to the transparently mapped data layout of the pre-evaluation part.

7. The method of claim 1, further comprising:
performing the transparent mapping of data layouts of the pre-evaluation part;
receiving a request to export the neural network from a current data layout to a subsequent data layout; and
executing the transparent mapping of data layouts of the pre-evaluation part backwards.

8. The method of claim 1, further comprising:
performing the transparent mapping of data layouts of the pre-evaluation part, and
storing an output of the pre-evaluation part in the neural network,
wherein the pre-evaluation part comprises a generative layer.

9. The method of claim 1, wherein handling the transparent mapping of the data layouts by the wrapper comprises:
receiving a parameter of the neural network;
generating a new neural network with a new parameter;
performing the transparent mapping of data layouts of the pre-evaluation part using the parameter of the neural network as an input and the new parameter of the new neural network as an output; and
replacing the neural network with the new neural network.

10. The method of claim 1, wherein handling the transparent mapping of the data layouts by the wrapper comprises:
detecting a data layout of the neural network;
detecting a data layout of a target device that will deploy the neural network;
creating a new neural network with the data layout of the target device; and
replacing the neural network with the new neural network.

11. The method of claim 10, wherein the wrapper detects the data layout of the neural network and detects the data layout of the target device that will deploy the neural network in response to a user execution of the neural network.

12. The method of claim 1, further comprising detecting a data layout of the neural network;
detecting a data layout of a target device that will deploy the neural network;
performing the transparent mapping of data layouts of the pre-evaluation part; and
replacing the neural network with a neural network that utilizes a data layout of the target device.

13. The method of claim 1, further comprising removing, by the wrapper, a parameter of the neural network in response to a user input.

14. A system for optimizing computation graphs of a neural network comprising one or more hardware processors which, alone or in combination, are configured to provide for execution of the following steps:
identifying parameters of a computation graph of the neural network that depend on input data as a computation part, and parameters of the computation graph that are independent of the input data as a pre-evaluation part;
splitting the computation graph into the pre-evaluation part and the computation part; and
generating and applying a wrapper that performs a transparent mapping of data layouts of the pre-evaluation part.

15. A tangible, non-transitory computer-readable medium having instructions thereon which, upon being executed by one or more hardware processors, alone or in combination, provide for execution of the following steps:
identifying parameters of a computation graph of the neural network that depend on input data as a computation part, and parameters of the computation graph that are independent of the input data as a pre-evaluation part;
splitting the computation graph into the pre-evaluation part and the computation part; and
generating and applying a wrapper that performs a transparent mapping of data layouts of the pre-evaluation par.
